(19) United States
(12) Patent Application Publication
(10) Pub. No.: US 2005/0253497 A1
(43) Pub. Date: Nov. 17, 2005

(54) Vacuum display device with reduced ion damage

(76) Inventors: Ramon Pascal Van Gorkom, Eindhoven (NL); Nijs Cornelis Van Der Vaart, Eindhoven (NL); Johannes Josephus Wilhelmus Maria Rosink, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/525,574

(22) PCT Filed: Jul. 21, 2003
(86) PCT No.: PCT/IB03/03296

§ 371 Date: Feb. 23, 2005

(30) Foreign Application Priority Data
Aug. 28, 2002 (EP) 02078534.1

(51) Int. Cl. H01J 31/26

(52) U.S. Cl. 313/373

(57) ABSTRACT

A display device has a display screen for displaying image information, and cathode means comprising an emitter material for emitting electrons. The emitted electrons are collected by an electron concentrator which redistributes the electrons in a homogenous electron beam (EB). The emitter material is arranged on a first surface excluding a first impact area on which positive ions land that pass through the electron concentrator. Therefore, substantially no emitter material is provided at the first impact area, so that damage inflicted on the cathode means by the positive ions is reduced. Preferably, the display device has a pumping chamber between the cathode means and a back plate, for removing residual gases from the display device.

The invention relates to a vacuum display device, comprising:
a display screen for displaying image information,
cathode means comprising an emitter material for emitting electrons, and
an electron concentrator for collecting the electrons, having an exit aperture for releasing an electron beam impinging on the display screen.

An embodiment of such a display device is for instance described in the unpublished European patent application 01204291.7.

In the described display device, the display screen comprises a number of picture elements (pixels) arranged in rows and columns. Each pixel corresponds to an electron beam guidance cavity, which concentrates and redistributes electrons emitted by the cathode means into an electron beam. Thus, in operation, each pixel receives a separate electron beam.

The electron beams are accelerated towards the display screen, because the display screen is supplied with a relatively high anode voltage, for instance 5 kilovolts. The pixels comprise luminescent material that emits light when struck by a beam of accelerated electrons. By addressing the pixels in accordance with image information supplied to the display device, said image information can be displayed on the display screen as a light image.

The display device is operated under vacuum conditions. However, a small amount of residual gases still remain after evacuation. When an electron collides with a residual gas atom, a positive ion is formed, which travels in the opposite direction to the electrons. Thus, positive ions travel towards the cathode means. This is undesired, since the positive ions damage the cathode means upon impact thereon.

To withstand the atmospheric pressure, the evacuated display device is generally provided with a screen spacer. The screen spacer is positioned between a channel plate that is provided with the electron beam guidance cavities and the display screen. Generally, the screen spacer is a spacer plate comprising a number of chambers, a chamber for example corresponding to a single pixel, a row of pixels, or a column of pixels.

The described display device has a relatively low rate of deterioration of image brightness over its lifetime. This is because the number of positive ions that impact on the cathode means is relatively small. Only the portion of the ions that pass through the relatively small exit aperture are able to reach the cathode means. As a result, the damage inflicted on the cathode means by positive ions is relatively low and the emission properties of the cathode means over the lifetime of the display device are fairly constant.

There is, however, still a desire to further reduce the number of positive ions that impact on the cathode means, and thus to further decrease the damage inflicted on the cathode means.

It is therefore an object of the invention to provide a vacuum display device as described in the opening paragraph, wherein the number of positive ions that impact on the cathode means is reduced further.

This object is achieved by the vacuum display device according to the invention as specified in the independent claim 1. Further advantageous embodiments are defined in the dependent claims 2-11.

Thus, a vacuum display device according to the invention is characterized in that the emitter material is arranged on a first surface, said first surface excluding a first impact area for receiving positive ions, said first impact area being arranged on a second surface facing the exit aperture and comprising a projection of the exit aperture on said second surface.

Within this patent application, the “first surface” should be construed as a surface, or part of a surface, on which the emitter material is provided.

The present invention is based on the recognition that the presence of the electron concentrator allows for a large freedom in design of the cathode means. More particularly, there is a large freedom in choosing the shape and/or the orientation of the first surface.

Whereas in a conventional display device a change in shape and/or orientation of the first surface would lead to a disturbed electron beam spot on the display screen, such a disturbance hardly occurs in a display device having the electron concentrator. The electron concentrator collects the emitted electrons and redistributes them into an electron beam. The shape of this electron beam is, among others, determined by the shape of the exit aperture of the electron concentrator, and the energy distribution of the electrons within the redistributed electron beam is relatively homogenous.

As a result, there is no longer a requirement for the first surface comprising the emitter material to be uninterrupted and directly face the display screen, while on the display screen an electron beam spot having a sufficiently high quality is still obtained. It is therefore possible to design the cathode means such, that the first impact area, on which positive ions land that passed through the exit aperture, is substantially free of emitter material.

In a preferred embodiment, the second surface at least partially comprises the first surface, said first surface enclosing the first impact area. Thus, the emitter material faces the exit aperture of the electron concentrator and encloses the projection of the electron concentrator on the second surface.

Preferably, the first surface is annularly shaped. The emitter material then encloses a circularly or elliptically shaped first impact area.

In a preferred embodiment, the first impact area is at least partially recessed. Positive ions landing on the first impact area generally sputter material from the second surface. This is undesired, since the sputtered material may be deposited inside the electron concentrator, and form a film on its inner wall, thereby degrading the operation of the electron concentrator. Moreover, the sputtered material may be deposited on the cathode means, and deteriorate the operation of the cathode means.

However, it is hard for the sputtered material to escape from a recess. So, if the first impact area is at least partially recessed, the sputtered material is predominantly trapped within the recess, and the amount of sputter material that escapes from the recess and is deposited inside the electron concentrator is reduced. Therefore, the operation of the electron concentrator over the lifetime of the display device is more constant.

Preferably, the display device comprises a pumping chamber on the emitter side of the electron concentrator, for removing residual gases. Within this application, the term “residual gases” is understood to encompass both gases remaining in the display device after evacuation and gases being formed in the display device during operation. If the amount of residual gases decreases, the number of positive ions formed therefrom is also reduced.

In the previously described display device, a pumping chamber was also provided, however it was positioned at the sides of the display device. The construction according to the present invention allows for an increased pumping speed, so that residual gases are removed more efficiently. Thus, the amount of residual gases inside the vacuum display is as low as possible. The pumping chamber should be in open connection with as much of the evacuated portions of the display device as possible, amongst others the electron concentrators and the chambers in the screen spacer plate.

The reduction of residual gases within the display device is especially important since these residual gases can also damage the cathode means directly, for instance by means of an oxidation process. The amount of damage inflicted on the cathode means by direct interaction with residual gases is thus also reduced by applying the pumping chamber.

In a preferred embodiment, the first surface substantially faces the pumping chamber. Thus, positive ions entering the electron concentrator through the exit aperture cannot reach the emitter material. Although the electrons are emitted in the direction of the pumping chamber, they can be drawn into the electron concentrator by a suitable electric field. In the electron concentrator, the electrons are mixed and rearranged into a relatively homogeneous electron beam.

For instance, the first surface and the second surface may be on opposite sides of an obstruction. The second surface receives the positive ions, while electrons emitted from the emitter material pass along the sides of the obstruction and into the electron concentrator.

Alternatively, the first surface substantially faces the exit aperture and encloses the first impact area. In a preferred embodiment thereof, said first impact area is provided with an aperture in connection with the pumping chamber, for passing the positive ions to said pumping chamber.

In this embodiment, the pumping chamber is in open connection with the other evacuated portions of the display device through the apertures. Thus, residual gases are able to reach the pumping chamber efficiently, and can particularly well be removed from the display device.

Moreover, positive ions now predominantly pass through the apertures so as to land in the pumping chamber at a relatively large distance from the cathode means and electron concentrator. Therefore, the ions hardly inflict damage on the cathode means, and there is no problem with sputtered material deposited inside the electron concentrator.

Preferably, the pumping chamber comprises a second impact area for receiving positive ions, said second impact area being at least partially recessed. The second impact area is for instance located on a back wall of the pumping chamber. If the first impact area is provided with apertures, the second impact area preferably comprises a projection of said apertures on the back wall of the pumping chamber.

The advantage of a recessed second impact area is similar to the advantage of a recessed first impact area, namely effective trapping of sputtered material within the recess. The amount of sputtered material that escapes from the recess is particularly small. In this case, the material is sputtered from the back wall of the pumping chamber.

In a preferred embodiment, the pumping chamber comprises a getter. In this way, the removal of residual gases is particularly efficient, and the pumping speed of the display device is particularly high. The getter may be arranged as a film covering the inner walls of the pumping chamber. Alternatively, the getter may be arranged only on the sides of the pumping chamber. The getter may, for instance, comprise barium (Ba).

The electron concentrator preferably comprises an electron beam guidance cavity being provided with secondary emission material, the entrance being larger than the exit aperture. Such an electron concentrator is described in the aforementioned unpublished European patent application 01204291.7. The electron transport through such a cavity is based on hopping of the electrons, which is a secondary emission process.

Generally, the inner surface of such a cavity comprises an electrically insulating material having a secondary emission function. When an electron strikes upon the inner surface, it is absorbed and a secondary electron is released and accelerated towards the exit aperture. For each electron that enters the cavity, one electron is emitted through the exit aperture on average. The cavity collects the electrons from the relatively large entrance, and concentrates and redistributes them into an electron beam exiting through the relatively small exit aperture.

Preferably, the emitter material comprises a field emitter. Field emitters require only a relatively low power for generating a sufficiently large number of electrons. Moreover, using field emitter material, it is easy to arrange the cathode means in any shape that is suitable for carrying out the present invention. Since field emitter material is also relatively sensitive to ion damaging, the use of the present invention in combination with cathode means comprising field emitter material is particularly advantageous.

These and other aspects of the invention will be apparent from and elucidated with reference to the embodiments described hereinafter.

### IN THE DRAWINGS

FIG. 1 is a first preferred embodiment of the display device according to the present invention;

FIG. 2 shows, in more detail, an embodiment of the cathode means suitable for use in the display device;

FIG. 3 is a second preferred embodiment of the display device according to the present invention and

FIG. 4 shows a third preferred embodiment of the display device according to the present invention.

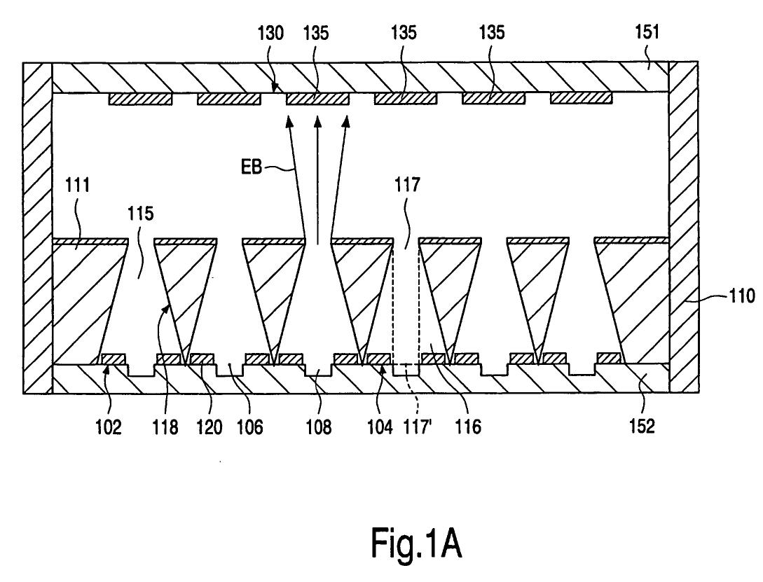

A first preferred embodiment of the display device has a display screen 130 arranged near a front plate 151, and cathode means 120 arranged near a back plate 152, for forming a plurality of electron beams EB. The display screen 130 comprises picture elements (pixels) 135. Whereas in FIG. 1 a display screen 130 is shown that has only a few pixels 135, a real display device has a much larger number of pixels, such as 800 by 600.

Each pixel 135 is provided with a luminescent material, for instance a phosphor, which emits light when it is struck by an electron beam EB. In a color display device, different luminescent materials are applied, each corresponding to one of the colors red, green and blue. The light travels through the front plate 151 towards a viewer, who watches the display device from the outside.

A channel structure 110 is arranged between the display screen 130 and the cathode means 120, in proximity of the latter. The channel structure 110 is provided with electron concentrators 115. Preferably, the electron concentrators 115 are electron beam guiding cavities that are substantially funnel-shaped, and have an entrance 116 for collecting the electrons emitted by the cathode means 120 and an exit aperture 117 for releasing an electron beam EB. Within the electron concentrators 115, the emitted electrons are redistributed and concentrated in the electron beam EB, which has a relatively high beam current.

For each pixel 135, the channel structure 110 has a corresponding electron concentrator 115. The inner surface 118 of an electron concentrator 115 is at least partially coated with an electrically insulating material having a secondary emission coefficient δ of at least one for a predetermined range of electron impact energies, so that the inner wall 118 is able to emit a secondary electron when an electron impinges on it. This allows for the so-called hopping transport of electrons through the electron concentrator 115. The secondary emission material comprises, for instance, magnesium oxide (MgO). The channel structure 110 has a thickness of for instance 400 μm.

For enabling the hopping electron transport, a hop electrode 111 is present at the screen-facing side of the electron concentrator 115. In operation, a hop voltage is applied to the hop electrode 111 for establishing an electric field within the electron concentrator 115. The hop voltage may have a constant value, or may preferably be used to control the beam current of the electron beam EB.

In the latter case, when the hop voltage is equal to a predetermined threshold hop voltage, the hopping transport of electrons starts. By increasing the hop voltage, the beam current of the electron beam EB increases. A maximum hop voltage corresponds to a voltage at which a peak beam current is emitted by the cathode means 120. For instance, the threshold hop voltage lies within a range from 50 to 200 volts, and the maximum hop voltage, being larger than the threshold hop voltage, lies within a range from 100 to 500 volts.

In general, the exit aperture 117 is smaller than the entrance 116 which faces the cathode means 120. Preferably, the ratio of the surface area of the entrance 116 to the exit aperture 117 should be considerably larger than 1, for instance it should be 5 or 20. For example, the diameter of the entrance 116 is 600 micrometers and the diameter of the exit aperture 117 is 100 micrometers. These values, combined with the thickness of the channel structure 110 (which is equal to the length of the electron concentrator 115) give an electron beam EB that has sufficiently high beam current, and a particularly uniform and homogeneous energy distribution.

Between the channel structure 110 and the display screen 130, a screen spacer is arranged, similar to the previously described display device.

By means of the electric fields within the display device, positive ions formed between the channel structure 110 and the display screen 130 are accelerated towards the channel structure 110. The exit aperture 117 is relatively small, so that the positive ions will predominantly impact on the screen-facing surface of the channel structure 110. However, a number of the positive ions passes through the exit aperture 117, and reaches the cathode means 120. These positive ions have relatively high energy, so that a substantial part of the total damage inflicted on the cathode means 120 originates from collision of positive ions formed between the channel structure 110 and the display screen 130.

To overcome this problem, the cathode means 120 are annularly shaped in this preferred embodiment, and enclose a first impact area 106 on the second surface 104. The projection of the exit aperture 117 on the second surface 104 is indicated in the drawing by the sign 117′. Preferably, this projection 117′ lies entirely within the first impact area 106.

Due to the annularly shaped cathode means 120, positive ions that enter the electron concentrator 115 through the exit aperture 117 hardly land on said cathode means 120. The number of collisions of positive ions with the cathode means 120 is reduced and image brightness over the lifetime of the display device is improved.

Advantageously, the first impact area comprises a recess 108 as indicated in the drawing. More advantageously, the second surface 104 is recessed at the location of the projection 117′ of the exit aperture 117. Material that is sputtered from the second surface by the impacting positive ions predominantly remains within the recess 108, and cannot contaminate the electron concentrator 115 or the field emitter material 224.

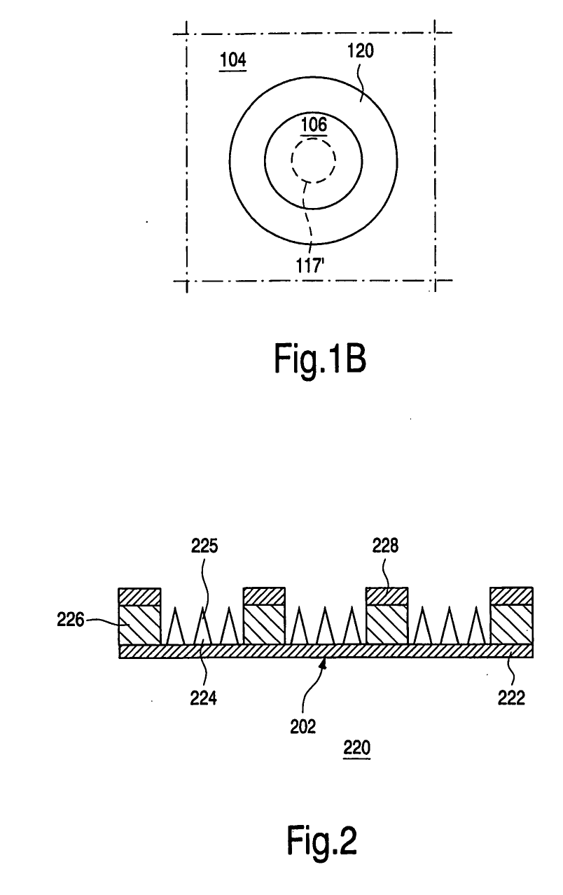

FIG. 2 shows in more detail a cross-section of cathode means 220 suitable for use in a display device according to the invention.

The cathode means 220 comprise a cathode electrode 222 deposited on the first surface 202 and field emitter material 224 deposited on the cathode electrode 222. The field emitter material 224 is provided within holes 225 in a resistive layer 226, which layer is covered with a gate electrode 228. In the drawing, the indicated field emitter material 224 consists of microtip emitters, but any other field emitter material, such as carbon nanotubes or graphite emitting particles, may be applied instead.

By applying a voltage difference between the cathode electrode 222 and the gate electrode 228, the field emitter material 224 is energizable for emitting electrons. This voltage difference can be relatively low, for instance a voltage difference of 100 Volts is sufficient to obtain an electron beam EB with a beam current of 20 microamperes.

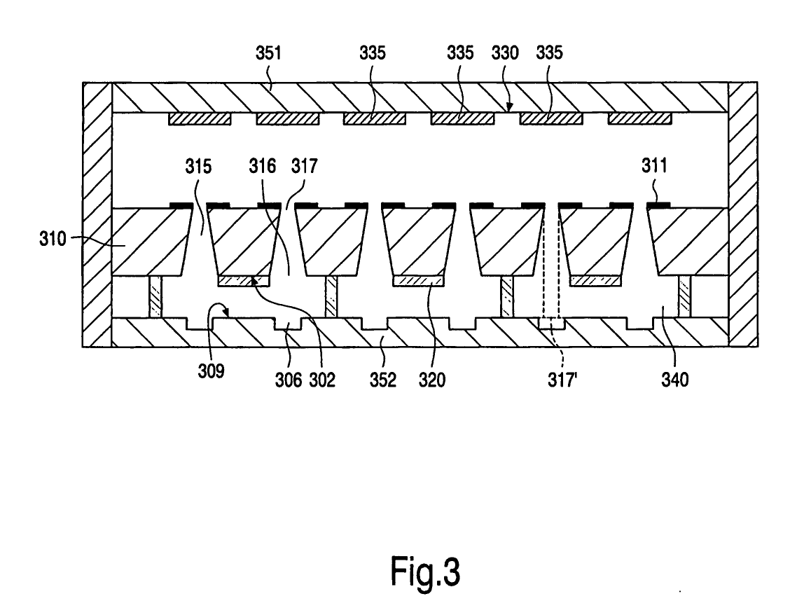

Another preferred embodiment of the display device according to the invention is shown in FIG. 3. In this embodiment, the display screen 330 and the channel structure 310 holding the electron concentrators 315 are similarly formed as in the previous embodiment.

In this embodiment, pumping chambers 340 are present between the back plate 352 and the channel structure 310. The pumping chambers 340 extend in a direction perpendicular to the plane of the drawing, from one side of the display device to the opposite side. The pumping chambers 340 function to remove residual gases which remain in the display device after evacuation. This is advantageous, since the damage inflicted on the cathode means 320 is decreased. Because of the lower residual gas pressure, less positive ions are formed, and direct interaction processes such as cathode oxidation are reduced.

The first surface 302 comprising the cathode means 320 faces the pumping chambers 340. Thus, the cathode means 320 is directed towards the back plate 352 of the display device, instead of towards the display screen 330. The second surface 304 faces the electron concentrator 315. The first impact area 306 comprises a projection 317′ of the exit aperture 317 on the second surface 304, and is preferably recessed.

The emitted electrons are emitted in the direction of the pumping chamber 340, but are deflected to pass into the electron concentrators 315 by means of an electric field. The electric field is preferably generated by suitably setting the hop voltage. The threshold hop voltage and the maximum hop voltage may be equal to the corresponding voltages in the first embodiment, or each of these voltages may be increased, for instance by 50 or 100 Volts.

In this particular embodiment, two adjacent electron concentrators 315 share a single cathode means 320. Preferably, the hop electrodes 311 for the adjacent electron concentrators 315 are then individually addressable, so that the beam currents of the electron beams exiting from the adjacent electron concentrators 315 can be modified independently.

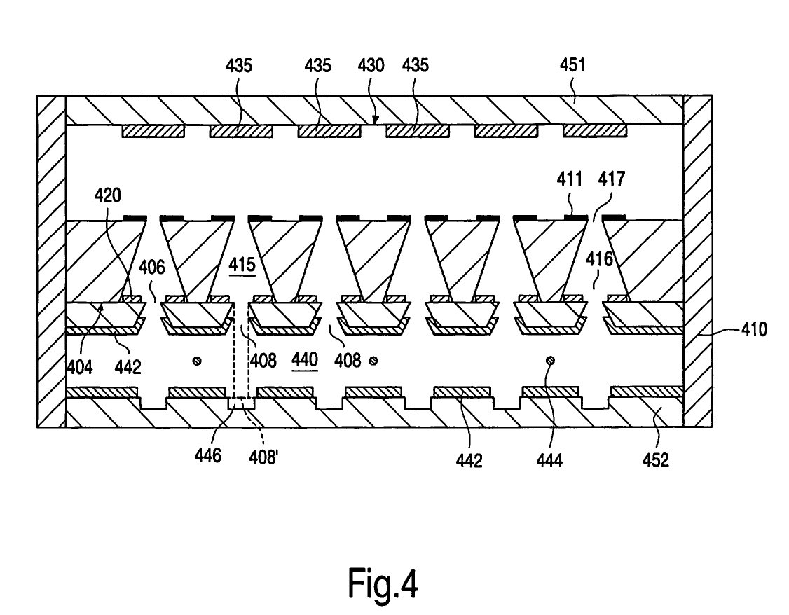

The previous two embodiments predominantly only lead to a reduction in ion damage. In the second embodiment, the increase in pumping speed is insufficient to noticeably reduce direct interaction effects. Therefore, in the third preferred embodiment as shown in FIG. 4, the pumping speed is increased greatly, and residual gases can be removed more efficiently. At the same time, ion damage is comparable to that in the other embodiments.

The third embodiment of the display device is comparable to the first embodiment, particularly the display screen 430 and the channel structure 410 holding the electron concentrators 415 are similarly formed. The first surface 402 comprising the cathode means 420 faces the display screen 430 and is arranged near the electron concentrators 415. The cathode means 420 have a similar shape to the first embodiment, for instance the cathode means 420 are annularly shaped, enclosing the first impact area 406.

A pumping chamber 440 is provided between the cathode means 420 and the back plate 452. The first impact area 406 on the second surface 404, which faces the electron concentrator 415, is now provided with an aperture 408. Positive ions that pass through the exit aperture 417 of the electron concentrator 415 now travel further through the aperture 408, into the pumping chamber 440.

Via aperture 408 the pumping chamber 440 is in open connection with other evacuated spaces in the display device, such as the electron concentrators 415 and the space between the channel structure 410 and the display screen 430. In this way, gas that is generated during device operation can travel through the aperture 408 into the pumping chamber 440, from which it is removed.

The pumping chamber 440 may be provided with a getter at the edges of the chamber, i.e. at the sides of the display device.

However, preferably the walls of the pumping chamber 440 are provided with a film 442 of getter material such as barium (Ba). In this case the pumping surface is relatively large and the gas only has to travel a short distance to reach a getter. These effects lead to a greatly increased pumping speed in this embodiment.

The positive ions that passed through the aperture 408 now land in a second impact area 446 comprising the projection 408′ of the aperture 408 on the back wall 452. The second impact area 446 is recessed and predominantly not covered with getter material. Without the recess, getter material could be sputtered by the positive ions and be redeposited on the cathode means 420, or in the electron concentrators 415. This would negatively affect the operation of the display device.

The getter material is initially provided in the form of for instance wires 444. During manufacturing of the display device, a so-called flashing step takes place whereby the getter material is activated and deposited on the inner walls of the pumping chamber 440. The getter material may be activated by heating the wires 444 to a sufficiently high temperature, whereby it is evaporated and deposited as a film 442 on the inner walls.

The pumping chamber 440 may be a single chamber covering substantially the same surface area as the display screen 430. However, usually an internal vacuum support is required in the pumping chamber 440.

The drawings are schematic and not drawn to scale. While the invention has been described in connection with preferred embodiments, it should be understood that the invention should not be construed as being limited to the preferred embodiments. Rather, it includes all variations which could be made thereon by a skilled person, within the scope of the appended claims.

Summarizing, the present invention relates to a display device that has a display screen for displaying image information, and cathode means comprising an emitter material for emitting electrons. The emitted electrons are collected by an electron concentrator which redistributes the electrons in a homogenous electron beam (EB). The emitter material is arranged on a first surface excluding a first impact area on which positive ions land that pass through the electron concentrator. Therefore, substantially no emitter material is provided at the first impact area, so that damage inflicted on the cathode means by the positive ions is reduced. Preferably, the display device has a pumping chamber between the cathode means and a back plate, for removing residual gases from the display device.

1. Vacuum display device, comprising:
a display screen (130) for displaying image information
cathode means (120) comprising an emitter material (224) for emitting electrons and
an electron concentrator (115) for collecting the electrons, having an exit aperture (117) for releasing an electron beam (EB) impinging on the display screen (130), characterized in that the emitter material (224) is arranged on a first surface (102), said first surface (102) excluding a first impact area (106) for receiving positive ions, said first impact area (106) being arranged on a second surface (104) facing the exit aperture (117) and comprising a projection (117′) of the exit aperture (117) on said second surface (104).

2. Display device as claimed in claim 1, characterized in that the second surface (104) at least partially comprises the first surface (102), said first surface (102) enclosing the first impact area (106).

3. Display device as claimed in claim 2, characterized in that the first surface (102) is annularly shaped.

4. Display device as claimed in claim 1, characterized in that the first impact area (106) is at least partially recessed.

5. Display device as claimed in claim 1, characterized in that the display device comprises a pumping chamber (340) on the emitter side of the electron concentrator (315), for removing residual gases.

6. Display device as claimed in claim 5, characterized in that the first surface (302) substantially faces the pumping chamber (340).

7. Display device as claimed in claim 2, characterized in that the first impact area (406) is provided with an aperture (408) in connection with the pumping chamber (440), for passing positive ions to said pumping chamber (440).

8. Display device as claimed in claim 5, characterized in that the pumping chamber (440) comprises a second impact area (408) for receiving positive ions, said second impact area (408) being at least partially recessed.

9. Display device as claimed in claim 5, characterized in that the pumping chamber (440) comprises a getter.

10. Display device as claimed in claim 1, characterized in that the electron concentrator (115) comprises an electron beam guidance cavity being provided with secondary emission material and having an entrance (116) being larger than the exit aperture (117).

11. Display device as claimed in claim 1, characterized in that the emitter material (224) comprises a field emitter.
